(19) United States
(12) Patent Application Publication
(10) Pub. No.: US 2014/0273846 A1
(43) Pub. Date: Sep. 18, 2014

(54) Data Transmission Method and Data Transmission System

(71) Applicant: National Cheng Kung University, Tainan City (TW)

(72) Inventors: Sheng-Tzong CHENG, Tainan City (TW); Jia-Shing SHIH, Taipei City (TW)

(21) Appl. No.: 13/919,698

(22) Filed: Jun. 17, 2013

(30) Foreign Application Priority Data
Mar. 18, 2013 (TW) 102109546

(51) Int. Cl. H04W 76/02; H04W 4/00

(52) U.S. Cl. CPC H04W 76/023; H04W 4/008
USPC 455/41.2

(57) ABSTRACT

A data transmission method comprises steps of: implement a first operation at a first time to generate a first operation information by a first mobile communication apparatus; implementing a second operation at a second time to generate a second operation information by a second mobile communication apparatus; implementing an identification procedure according to the first time, the first information, the second time and the second information; and determining if a data of the first mobile communication apparatus is transmitted to the second mobile communication apparatus through a communication interface according to the result of the identification procedure. A data transmission system is also disclosed. By the data transmission method and system, the data transmission between the mobile communication apparatuses can be performed more intuitively and conveniently.

### CROSS REFERENCE TO RELATED APPLICATIONS

This Non-provisional application claims priority under 35 U.S.C. §119(a) on patent application Ser. No(s). 102109546 filed in Taiwan, Republic of China on Mar. 18, 2013, the entire contents of which are hereby incorporated by reference.

### BACKGROUND OF THE INVENTION

1. Field of Invention

The invention relates to a data transmission method and, in particular, to a data transmission method and a data transmission system.

2. Related Art

Mobile communication apparatuses have numerously appeared in our daily life and brought various and extensive applications. However, some inconveniences in using them are still required to be solved. For example, for the data transmission, a mobile communication apparatus must connect to a third-party server or a network appliance before communicating with other mobile communication apparatuses, and therefore the data transmission is so limited by the network environment. Besides, users sometimes must complete the network setting or pairing before they transmit or share files or data, and thus the operation of data transmission becomes more complicated and is not convenient for users.

Therefore, it is an important subject to provide a data transmission method and a data transmission system so that users can carry out the data transmission in an intuitive way and without the limitation of the network environment for enhancing the use convenience and product competitiveness.

### SUMMARY OF THE INVENTION

In view of the foregoing subject, an objective of this invention is to provide a data transmission method and a data transmission system so that users can carry out the data transmission in an intuitive way and without the limitation of the network environment.

To achieve the above objective, a data transmission method according to this invention comprises steps of: implement a first operation at a first time to generate a first operation information by a first mobile communication apparatus; implementing a second operation at a second time to generate a second operation information by a second mobile communication apparatus; implementing an identification procedure according to the first time, the first information, the second time and the second information; and determining if a data of the first mobile communication apparatus is transmitted to the second mobile communication apparatus through a communication interface according to the result of the identification procedure.

To achieve the above objective, a data transmission system according to this invention comprises a first mobile communication apparatus and a second mobile communication apparatus. The first mobile communication apparatus includes an identification unit and a first communication unit, and generates a first operation information at a first time by a first operation. The second mobile communication apparatus includes a second communication unit and generates a second operation information at a second time by a second operation. The identification unit implements an identification procedure according to the first time, the first operation information, the second time and the second operation information, and the first mobile communication apparatus determines if a data thereof is transmitted to the second mobile communication apparatus through the first communication unit and second communication unit according to the result of the identification procedure.

In one embodiment, when it is determined that the first and second operation information are substantially the same and the first and second times are substantially equal to each other, the data is transmitted to the second mobile communication apparatus.

In one embodiment, when it is determined that the first and second operation information are substantially the same and the second time lies within a range of the first time, the data is transmitted to the second mobile communication apparatus.

In one embodiment, the communication interface is in conformity to Wi-Fi or Wi-Fi direct.

In one embodiment, the communication interface supports point-to-point transmission.

In one embodiment, before implementing the first operation, the data transmission method further comprises a step of: selecting the data stored therein by the first mobile communication apparatus.

In one embodiment, each of the first and second operations includes the rotation, straight movement, crooked movement, touch control or their any combination.

In one embodiment, before implementing the second operation, the data transmission method further comprises a step of: putting the first and second mobile communication apparatuses together.

In one embodiment, before implementing the second operation, the data transmission method further comprises a step of stacking the first and second mobile communication apparatuses.

In one embodiment, the data transmission method further comprises steps of: converting the first operation information into a first conversion information; and converting the second operation information into a second conversion information, wherein the first and second conversion information are compared in the identification procedure.

In one embodiment, the first operation information is generated by a sensing unit of the first mobile communication apparatus.

In one embodiment, the first mobile communication apparatus further includes a first conversion unit converting the first operation information into a first conversion information, the second mobile communication apparatus further includes a second conversion unit converting the second operation information into a second conversion information, and the identification unit implements the identification procedure according to the first time, the first conversion information, the second time and the second conversion information.

In one embodiment, the identification unit is generated by executing a program,

In one embodiment, the program is downloaded from Internet or obtained from a storage apparatus.

As mentioned above, in the data transmission method and system of the invention, a plurality of the mobile communication apparatuses are handled to generate a plurality of the operation information, and the identification procedure is implemented according to the generated operation information and operation time to determine if the data transmission is performed. Thereby, the user can complete the data transmission just by taking the mobile communication apparatus to do the simple operation, such as moving the mobile communication apparatus or plotting a figure on the touch screen of the mobile communication apparatus. In other words, the network transmission setting and pairing can be avoided. Therefore, by the data transmission method and system of this invention, the data transmission between the mobile communication apparatuses can be implemented more intuitively and conveniently, and can be achieved without through the third-party server so as to be unlimited by the network environment. Besides, the data transmission method and system of this invention can be applied, for example, to the data transmission between small-scale household appliances (such as remote controls) or to the business field (e.g. card exchanging, electronic payment). Accordingly, the invention discloses a concept that the data transmission is completed by an intuitive friendly coordination operation, and thus has the following advantages of simple operation free of the wireless communication setting, skipping the friend list or social networking, intuitive friendly coordination operation, and avoiding the limitation of the third-party server and network environment.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a flow chart of a data transmission method of a preferred embodiment of this invention;

FIGS. 2 to 4 are schematic diagrams of a practical application of a data transmission method of a preferred embodiment of this invention;

FIG. 5 is a schematic diagram showing the process of the identification procedure of the practical application in FIGS. 2 to 4;

FIG. 6 is a schematic diagram of another practical application of a data transmission method of a preferred embodiment of this invention;

FIG. 7 is a schematic diagram showing the process of the identification procedure of the practical application in FIG. 6; and

FIG. 8 is a schematic block diagram of a data transmission system according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

FIG. 1 is a flow chart of a data transmission method of a preferred embodiment of this invention, including the steps S01 to S04. The data transmission method of this embodiment is illustrated by referring to FIG. 1.

The step S01 is to implement a first operation at a first time to generate a first operation information by a first mobile communication apparatus. The first mobile communication apparatus is not limited in type in this embodiment, which can be a tablet compute, a smart phone, etc. The first operation can include the movement of the first mobile communication apparatus, such as rotation, straight movement or crooked movement of the first mobile communication apparatus or their any combination. Otherwise; the first operation can include the touch control of the touch screen of the first mobile communication apparatus to input figures, symbols or words for example. Otherwise, the first operation can include the movement and touch control of the first mobile communication apparatus. When the first mobile communication apparatus implements the first operation, a sensing unit of the first mobile communication apparatus can sense the condition to generate the first operation information. The sensing unit is a gyroscope or a touch screen for example. The gyroscope can be applied to the movement of the first mobile communication apparatus, and the touch screen can be applied to the touch control of the first mobile communication apparatus. The above sensing unit is just for example but not for limiting the scope of the invention.

The step S02 is to implement a second operation at a second time to generate a second operation information by a second mobile communication apparatus. The second mobile communication apparatus is not limited in type in this embodiment, which can be a tablet compute, a smart phone, etc. The second operation can include the movement of the second mobile communication apparatus, such as rotation, straight movement or crooked movement of the second mobile communication apparatus or their any combination. Otherwise, the second operation can include the touch control of the touch screen of the second mobile communication apparatus to input figures, symbols or words for example. Otherwise, the second operation can include the movement and touch control of the second mobile communication apparatus. When the second mobile communication apparatus implements the second operation, a second mobile communication information. The apparatus can sense the condition to generate the second operation information. The sensing unit is a gyroscope or a touch screen for example. The gyroscope can be applied to the movement of the second mobile communication apparatus, and the touch screen can be applied to the touch control of the second mobile communication apparatus. The above sensing unit is just for example but not for limiting the scope of the invention.

In this embodiment, the data transmission is carried out only when the first operation and the second operation are the same. So, in order to efficiently make the first and second operations the same, the data transmission method can include, before the first and second operations are implemented, a step of putting the first and second mobile communication apparatuses together and even stacking them. Thus, when the movement operations of the first and second mobile communication apparatuses are implemented, the first operation is substantially equal to the second operation.

The step S03 is to implement an identification procedure according to the first time, the first information, the second time and the second information. Besides, the step S04 is to determine if a data of the first mobile communication apparatus is transmitted to the second mobile communication apparatus through a communication interface according to the result of the identification procedure. In this embodiment, when it is determined that the first and second operations are substantially the same and the first and second times are substantially equal to each other, the data will be transmitted to the second mobile communication apparatus. Otherwise, when it is determined that the first and second operations are substantially the same and the second time lies within a range of the first time, the data will be transmitted to the second mobile communication apparatus. Thereby, the data transmission can be completed. In this embodiment, the communication interface is in conformity to Wi-Fi, Wi-Fi direct, or other kinds of communication protocols, such as a protocol supporting point-to-point transmission.

Besides, before implementing the first operation, the data transmission method can further include a step of selecting a stored data, i.e. the data to be transmitted to the second mobile communication apparatus, by the first mobile communication apparatus. In this case, the first mobile communication apparatus is defined as a transmitting end, and broadcasts the related information outward so as to establish the connection with the second mobile communication apparatus. Therefore, the second mobile communication apparatus can be aware of transmitting the second operation information to the first mobile communication apparatus for the identification, and also the first mobile communication apparatus can be aware of transmitting the data to the second mobile communication apparatus if the result of the identification procedure is validated. The above-mentioned broadcasting can be implemented at another time, such as in the meantime of the first operation.

The data transmission method can further include steps of: converting the first operation information into a first conversion information; and converting the second operation information into a second conversion information, wherein the first and second conversion information will be compared in the identification procedure. Thereby, the amount of the information need to be compared can be reduced, or the criteria of the comparison can be simplified or lowered down. For example, the first operation information in the case of moving the mobile communication apparatuses is of an x-axial rotation while the second operation information is of a y-axial rotation, but they are both converted into the “rotation” as the first and second conversion information. Otherwise, in the case of the touch control, a user plots a rectangle on the touch screen of the first mobile communication apparatus while another user plots a trapezoid on the touch screen of the second mobile communication apparatus, but both figures are converted into the “rectangle” as the first and second conversion information. Therefore, the database capacity required for the identification procedure can be reduced, and also the criteria for the data transmission can be lowered down.

The following is a practical application to illustrate the data transmission method of this embodiment. FIG. 2 is a schematic diagram of the first mobile communication apparatus 11 and second mobile communication apparatus 12 applied to the data transmission method according to the invention. First, the data stored in the first mobile communication apparatus 11 is selected for being transmitted to the second mobile communication apparatus 12. Herein, as shown in FIG. 2, an image displayed by the first mobile communication apparatus 11 shows four files A, B, C, D, and the user selects the files B and D for the second mobile communication apparatus 12.

Then, the first and second operations will be implemented. Because this case is with regard to the movement of the mobile communication apparatus, the first and second mobile communication apparatuses 11 and 12 can be stacked as shown in FIG. 3 (they may be not stacked in other embodiments) first. Then, a first operation is implemented at a first time by the first mobile communication apparatus 11 to generate a first operation information. Besides, due to the stacking, a second operation is also implemented at a second time by the second mobile communication apparatus 12 to generate a second information. Substantially, the first time is equal to the second time, the first operation is equal to the second operation, and the first operation information is equal to the second operation information. Then, the second mobile communication apparatus 12 transmits the second time and the second operation information to the first mobile communication apparatus 11. Thereby, the first mobile communication apparatus 11 can implement an identification procedure according to the first time, the first operation information, the second time and the second operation information, and determines that the first operation information is equal to the second operation information and the first time is equal to the second time. Therefore, the first mobile communication apparatus 11 transmits the selected data (i.e. the files B and D) to the second mobile communication apparatus 12. As shown in FIG. 4, an image displayed by the second mobile communication apparatus 12 shows the added files B and D.

FIG. 5 is a schematic diagram showing the process of the identification procedure AP according to this embodiment. As shown in FIG. 5, the first operation of the first mobile communication apparatus 11 continues for six seconds for example. In the meantime of the first operation, the sensing unit of the first mobile communication apparatus 11 also senses the condition continuously to generate the first operation information (denoted by RD, RU, LD, LU in FIG. 5 for example). Likewise, the sensing unit of the second mobile communication apparatus 12 also senses the condition continuously to generate the second operation information. To be noted, although the first and second mobile communication apparatuses 11 and 12 are stacked and moved together, their generated operation information may be slightly different from each other in the same motion at the same time because of the factors of the electronic elements or the sensing functionality. Nevertheless, at the fifth second (i.e. 00:05), they have the same operation information. Therefore, when the first mobile communication apparatus 11 determines that the first and second operation information are substantially the same and the first and second times are substantially the same, the first mobile communication apparatus 11 transmits the selected data to the second mobile communication apparatus 12. Otherwise, the above-mentioned RD, RU, LD, LU in the identification procedure also can denote the first and second conversion information.

The following is the case with regard to the touch control for the first and second operations. FIG. 6 is a schematic diagram of the first and second mobile communication apparatuses 11 and 12 implementing the first and second operations, and FIG. 7 is a schematic diagram showing the identification procedure API of this practical application. As shown in FIGS. 6 and 7, a user plots a rectangle-like figure on the touch screen of the first mobile communication apparatus 11 at the first second (i.e. 00:01) as the first operation, and another user, seeing the figure plotted by the former user, also starts to plot a rectangle-like figure on the touch screen 122 of the second mobile communication apparatus 12 at the 2nd second (00:02) as the second operation. However, the two rectangle-like figures may be not totally the same actually. In this embodiment, the first mobile communication apparatus 11 can convert the first operation information into the “rectangle” as the first conversion information, and the second mobile communication apparatus 12 also can convert the second operation information into the “rectangle” as the second conversion information. Besides, the first mobile communication apparatus 11 determines if the second time lies within a range of the first time, the range being 5 seconds for example. As indicated by the identification procedure API in FIG. 7, the first mobile communication apparatus 11 generates the first conversion information (CR) and the first time (00:01) at the 1st second, and the second mobile communication apparatus 12 generates the second conversion information (TR) and the second time (00:02) at the 2nd second. In this situation, although the second time lies within the range of the first time, the first conversion information is different from the second conversion information, and therefore the identification is not validated. At the 4th second (00:04), the second mobile communication apparatus 12 generates the second conversion information (CR) and the second time (00:04). In this situation, the second time lies within the range of the first time, and the first conversion information is the same as the second conversion information, and therefore the identification is validated. Accordingly, the first mobile communication apparatus 11 transmits the data to the second mobile communication apparatus 12.

FIG. 8 is a schematic block diagram of a data transmission system according to a preferred embodiment of the invention. As shown in FIG. 8, the data transmission system includes a first mobile communication apparatus 21 and a second mobile communication apparatus 22. The first mobile communication apparatus 21 can be the above-mentioned first mobile communication apparatus 11, and the second mobile communication apparatus 22 can be the above-mentioned second mobile communication apparatus 12. The first mobile communication apparatus 21 includes an identification unit 213 and a first communication unit 214, and generates a first operation information at a first time by a first operation. The first operation information can be generated by a sensing unit 215 sensing the first operation. The second mobile communication apparatus 22 includes a second communication unit 223, and generates a second operation information at a second time by a second operation. The second operation information can be generated by a sensing unit 224 sensing the second operation. In other embodiments, the second mobile communication apparatus 22 can further include an identification unit which has the same function as the identification unit 213. The identification unit 213 can be generated by executing a program, which can be downloaded from Internet or obtained from a storage apparatus (e.g. an optical disk or a USB disk).

The identification unit 213 implements an identification procedure according to the first time, the first operation information, the second time and the second operation information. The first mobile communication apparatus 21 determines if a data thereof is transmitted to the second mobile communication apparatus 22 through the first communication unit 214 and the second communication unit 223 according to the result of the identification procedure. When it is determined that the first and second operation information are substantially the same and the first and second times are substantially equal to each other, the first mobile communication apparatus 21 transmits the data to the second mobile communication apparatus 22. Otherwise, when it is determined that the first and second operation information are substantially the same and the second time lies within a range of the first time, the first mobile communication apparatus 21 transmits the data to the second mobile communication apparatus 22.

The first and second operations include the rotation, straight movement, crooked movement, touch control or their any combination for example. The sensing units 215 and 224 are a gyroscope or touch screen each for example. The gyroscope can be applied to the case with regard to the movement of the mobile communication apparatus, and the touch screen can be applied to the case with regard to the touch control of the mobile communication apparatus. The above sensing unit is just for example but not for limiting the scope of the invention. Besides, the first and second mobile communication apparatuses 21 and 22 can be stacked, and thus the first operation is substantially equal to the second operation when the first and second mobile communication apparatuses 21 and 22 are operated to move.

The first and second communication units 214 and 223 can use the communication interfaces in conformity to Wi-Fi, Wi-Fi direct, or other kinds of communication protocols, such as a protocol supporting point-to-point transmission.

The first mobile communication apparatus 21 can further include a first conversion unit 216, which converts the first operation information into a first conversion information. The second mobile communication apparatus 22 can further include a second conversion unit 225, which converts the second operation information into a second conversion information. The identification unit 213 implements the identification procedure according to the first time, the first conversion information, the second time and the second conversion information.

Other technical features of the first and second mobile communication apparatuses 21 and 22 have been clearly illustrated in the above embodiments of the data transmission method, and therefore they are not described here for conciseness.

In summary, in the data transmission method and system of the invention, a plurality of the mobile communication apparatuses are handled to generate a plurality of the operation information, and the identification procedure is implemented according to the generated operation information and operation time to determine if the data transmission is performed. Thereby, the user can complete the data transmission just by taking the mobile communication apparatus to do the simple operation, such as moving the mobile communication apparatus or plotting a figure on the ouch screen of the mobile communication apparatus. In other words, the network transmission setting and pairing can be avoided. Therefore, by the data transmission method and system of this invention, the data transmission between the mobile communication apparatuses can be implemented more intuitively and conveniently, and can be achieved without through the third-party server so as to be unlimited by the network environment. Besides, the data transmission method and system of this invention can be applied, for example, to the data transmission between small-scale household appliances (such as remote controls) or to the business field (e.g. card exchanging, electronic payment). Accordingly, the invention discloses a concept that the data transmission is completed by an intuitive friendly coordination operation, and thus has the following advantages of simple operation free of the wireless communication setting, skipping the friend list or social networking, intuitive friendly coordination operation, and avoiding the limitation of the third-party server and network environment.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A data transmission method, comprising steps of:
implement a first operation at a first time to generate a first operation information by a first mobile communication apparatus;
implementing a second operation at a second time to generate a second operation information by a second mobile communication apparatus;
implementing an identification procedure according to the first time, the first information, the second time and the second information; and
determining if a data of the first mobile communication apparatus is transmitted to the second mobile communication apparatus through a communication interface according to the result of the identification procedure.

2. The data transmission method as recited in claim 1, wherein when it is determined that the first and second operation information are substantially the same and the first and second times are substantially equal to each other, the data is transmitted to the second mobile communication apparatus.

3. The data transmission method as recited in claim 1, wherein when it is determined that the first and second operation information are substantially the same and the second time lies within a range of the first time, the data is transmitted to the second mobile communication apparatus.

4. The data transmission method as recited in claim 1, wherein the communication interface is in conformity to Wi-Fi or Wi-Fi direct.

5. The data transmission method as recited in claim 1, wherein the communication interface supports point-to-point transmission.

6. The data transmission method as recited in claim 1, before implementing the first operation, further comprising a step of:
selecting the data stored therein by the first mobile communication apparatus.

7. The data transmission method as recited in claim 1, wherein each of the first and second operations includes the rotation, straight movement, crooked movement, touch control or their any combination.

8. The data transmission method as recited in claim 1, before implementing the second operation, further comprising a step of:
putting the first and second mobile communication apparatuses together.

9. The data transmission method as recited in claim 1, before implementing the second operation, further comprising a step of:
stacking the first and second mobile communication apparatuses.

10. The data transmission method as recited in claim 1, further comprising steps of:
converting the first operation information into a first conversion information; and
converting the second operation information into a second conversion information, wherein the first and second conversion information are compared in the identification procedure.

11. A data transmission system, comprising:
a first mobile communication apparatus including an identification unit and a first communication unit and generating a first operation information at a first time by a first operation; and
a second mobile communication apparatus including a second communication unit and generating a second operation information at a second time by a second operation,
wherein the identification unit implements an identification procedure according to the first time, the first operation information, the second time and the second operation information, and the first mobile communication apparatus determines if a data thereof is transmitted to the second mobile communication apparatus through the first communication unit and second communication unit according to the result of the identification procedure.

12. The data transmission system as recited in claim 11, wherein when it is determined that the first and second operation information are substantially the same and the first and second times are substantially equal to each other, the data is transmitted to the second mobile communication apparatus.

13. The data transmission system as recited in claim 11, wherein when it is determined that the first and second operation information are substantially the same and the second time lies within a range of the first time, the data is transmitted to the second mobile communication apparatus.

14. The data transmission system as recited in claim 11, wherein the communication interfaces of the first and second communication units are in conformity to Wi-Fi or Wi-Fi direct.

15. The data transmission system as recited in claim 11, wherein the first and second communication units support point-to-point transmission.

16. The data transmission system as recited in claim 11, wherein each of the first and second operations includes the rotation, straight movement, crooked movement, touch control or their any combination.

17. The data transmission system as recited in claim 11, wherein the first operation information is generated by a sensing unit of the first mobile communication apparatus.

18. The data transmission system as recited in claim 11, wherein the first and second mobile communication apparatuses are stacked with each other.

19. The data transmission system as recited in claim 11, wherein the first mobile communication apparatus further includes a first conversion unit converting the first operation information into a first conversion information, the second mobile communication apparatus further includes a second conversion unit converting the second operation information into a second conversion information, and the identification unit implements the identification procedure according to the first time, the first conversion information, the second time and the second conversion information.

20. The data transmission system as recited in claim 11, wherein the identification unit is generated by executing a program,

21. The data transmission system as recited in claim 20, wherein the program is downloaded from Internet or obtained from a storage apparatus.
